(19) United States
(12) Patent Application Publication
(10) Pub. No.: US 2025/0121559 A1
(43) Pub. Date: Apr. 17, 2025

(54) Multifunctional Toolhead Three Dimensional Printer

(71) Applicant: Jesse Mills, Palisade, CO (US)

(72) Inventor: Jesse Mills, Palisade, CO (US)

(21) Appl. No.: 18/886,153

(22) Filed: Sep. 16, 2024

Related U.S. Application Data
(60) Provisional application No. 63/544,047, filed on Oct. 13, 2023.

(51) Int. Cl. B29C 64/147; B29C 64/314; B29C 64/379; B33Y 10/00; B33Y 30/00; B33Y 40/10

(52) U.S. Cl. CPC B29C 64/147; B29C 64/314; B29C 64/379; B33Y 10/00; B33Y 30/00; B33Y 40/10

(57) ABSTRACT

The invention relates to a three-dimensional printing system and method for producing objects by cutting, stacking, and adhering layers of material. The system comprises a laser cutting system, vacuum retention system, adhesive application system, and material stacking plane integrated on a platform base with a multi-axis frame. The method involves configuring outcomes, cutting layers, applying adhesive, and stacking layers precisely. The system is compatible with various materials and scalable for different object sizes and production volumes. Software integration allows for complex object design and slicing, considering layer thickness and design constraints.

### CROSS-REFERENCE TO RELATED APPLICATIONS

This application claims the benefit of U.S. Provisional Patent Application 63/544,047, filed on Oct. 13, 2023, which is hereby incorporated by reference in its entirety.

### FIELD OF THE INVENTION

The invention is directed to a three-dimensional printing system featuring a tool head configured to cut and attach to material, and facilitate relocation of material to and from different locations within the system.

### BACKGROUND OF THE INVENTION

Three-dimensional printers of various configurations are well-known in the art. While many can construct objects in various orientations and via different mechanisms, a variety of challenges associated with previously known three-dimensional printers remain unsolved.

One such challenge pertains to the flexibility of materials utilized by a three-dimensional material. While many such systems utilize filaments of various composition, including plastic, resin, metal and carbon, filament-based printers often are not well-suited for many various applications. For instance, the cost and relatively slow speed associated with many such systems makes the creation of packaging impractical.

Other printers, such as those manufactured by GlowForge, combine subtractive manufacturing with laser-engraving and laser-cutting technologies. Such systems, however, fail to efficiently and effectively transfer materials from one aspect to another. Such systems often require excessive manual human input or process steps to facilitate the construction of a desired object in a non-automated manner. These and other systems lack mechanisms to automate several of the key steps associated with creating the shaped elements needed to create an object and then assemble the shaped elements in a way that achieves a desired object.

It therefore remains to be discovered an invention that addresses these and other imperfections associated with the field of three-dimensional printing systems.

### SUMMARY OF THE INVENTION

The preferred embodiment of the present invention is a three-dimensional printer featuring a Laser Cutting System, a Vacuum Retention System, a Laser-Vacuum Toolhead, a plurality of motors, an Adhesive Application System a Material Stacking Plane, a Cutting Area, a ZY-Axis Frame, a Y-Axis Crossbar and a Platform Base.

### BRIEF DESCRIPTION OF THE DRAWINGS

FIG. 1 depicts a top down view of exemplary aspects of an embodiment comprising the adhesive application system.

FIG. 2 depicts a top perspective view of exemplary aspects of an embodiment comprising the cutting area.

FIG. 3 depicts a top perspective view of exemplary aspects of an embodiment comprising the material stacking plane and the cutting area.

FIG. 4. depicts a top perspective view of exemplary aspects of an embodiment comprising the cutting area, laser-vacuum head, and adhesive application system.

FIG. 5 depicts an exemplary aspects of a y-axis crossbar and a laser-vacuum toolhead.

FIG. 6 depicts an embodiment of the vertical actuator and associated aspects of an embodiment.

FIG. 7a depicts a cross-sectional view of the adhesive application system in an embodiment.

FIG. 7b depicts an exemplary use of the adhesive application system in association with an intended methods of use of an embodiment.

FIG. 8a depicts a cross sectional view of an embodiment of the laser-vacuum head retaining an object as it grazes the adhesive application system in associated with an intended method of use of an embodiment.

FIG. 8b depicts a top perspective view of aspects of the adhesive application system in an embodiment.

FIG. 9 depicts a side view of an embodiment of the system.

FIG. 10 depicts an embodiment of the upper gear and lower gear associated with the adhesive application system.

FIG. 11a depicts a top down overview of the system in an example.

FIG. 11b depicts an example of the stacking of an object in an exemplary use of the system and methods described herein.

FIG. 12 depicts a top down view of cut materials in accordance with the laser cutting aspects of an exemplary embodiment of the invention.

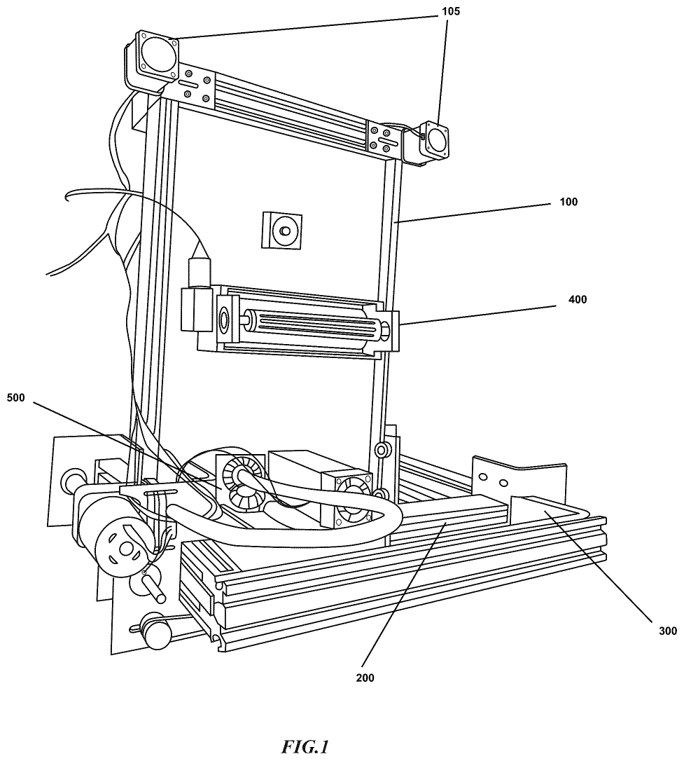

### DETAILED DESCRIPTION OF THE INVENTION

### System

The preferred embodiment of the invention is a system to produce a three-dimensional Object 1000. comprising a Laser-Vacuum Toolhead 500, a Cutting Area 110, an Adhesive Application System 400, and a Material Stacking Plane 120.

Embodiments of the system comprise a Platform Base 100. The Platform Base 100 in an example provides a platform to support and elevate the other components of the system. In the preferred embodiment, the Platform Base 100 is configured to elevate the Cutting Area 110 and the Material Stacking Plane 120 to approximately a standard tabletop height. Collectively, the Material Stacking Plane 120 and the Cutting Area 110 are referred to as the “tabletop area” herein. The Platform Base 100 in various embodiments provides a sturdy frame for placement and support of the other aspects of the system. In the preferred embodiment, the Platform Base 100 is 2420 mm long by 1540 mm wide, and 1180 mm tall. In the preferred embodiment, the Cutting Area 110 is approximately one square meter.

In an embodiment of the invention, the Material Stacking Plane 120 comprises a critical component of the three-dimensional printing system. The Material Stacking Plane 120, along with the Cutting Area 110, in accordance with an embodiment is collectively be referred to as the “tabletop area” of the system.

In this embodiment, the Material Stacking Plane 120 in an embodiment is supported and elevated by the Platform Base 100. The Platform Base 100 may be configured to elevate the Material Stacking Plane 120 to approximately a standard tabletop height, providing a stable and accessible surface for the stacking of layers during the printing process.

The construction of the Material Stacking Plane 120 in this embodiment in an embodiment is designed to provide a flat, level surface capable of supporting the weight of multiple stacked layers. The surface material in an embodiment is chosen for its durability and compatibility with the adhesives used in the system. Potential materials for the Material Stacking Plane 120 in an embodiment comprises high-density plastics, metals, or composite materials that offer both strength and a smooth surface finish.

In terms of dimensions, while specific measurements for the Material Stacking Plane 120 are not provided, in an embodiment it is part of the overall system dimensions. The Platform Base 100, which supports both the Material Stacking Plane 120 and the Cutting Area 110, may be 2420 mm long by 1540 mm wide, and 1180 mm tall. The Cutting Area 110 is described as approximately one square meter, and in an embodiment Material Stacking Plane 120 has similar or complementary dimensions to accommodate the stacked layers.

The interaction between the Material Stacking Plane 120 and the stacked layers in this embodiment may be facilitated by the Laser-Vacuum Toolhead 500. After a layer is cut in the Cutting Area 110 and adhesive is applied via the Adhesive Application System 400, the Laser-Vacuum Toolhead 500 in an embodiment is transports the layer to a designated location on the Material Stacking Plane 120. The precise positioning of each layer in an embodiment is controlled by the system's motors and software, allowing for accurate stacking and alignment of successive layers.

The Material Stacking Plane 120 in this embodiment may work in conjunction with the Adhesive Application System 400 to ensure proper bonding between layers. As each layer is placed on the Material Stacking Plane 120, the adhesive applied to its underside cures, bonding it to the layer beneath. The flat surface of the Material Stacking Plane 120 in an embodiment ensures that each layer remains level and properly aligned during this process.

In this embodiment, the Material Stacking Plane 120 may also serve as the final build platform for the completed three-dimensional object. Once all layers have been stacked and the adhesive has fully cured, the finished object in an embodiment is removed from the Material Stacking Plane 120 for any final processing or use.

In an embodiment of the invention, the three-dimensional printing system is designed to be compatible with a wide range of materials. While the document primarily mentions wood, acrylic, and certain types of plastics, the system's versatility in an embodiment allows for the use of various other materials.

The Laser Cutting System 520 in this embodiment is capable of cutting and engraving a diverse array of materials. The 450 nm wavelength laser in an embodiment is particularly effective for processing materials such as:
Wood: Various types of wood, including plywood, MDF, and hardwoods, in an embodiment is cut and engraved with precision.
Acrylic: Both cast and extruded acrylic sheets of different thicknesses in an embodiment is compatible with the system.
Plastics: A range of thermoplastics, including but not limited to PET, PETG, ABS, and polycarbonate, in an embodiment is processed by the laser.
Paper and cardboard: The system in an embodiment is capable of cutting and scoring different weights of paper and cardboard, making it suitable for packaging applications.
Leather: Both natural and synthetic leather in an embodiment is cut and engraved, potentially allowing for custom leather goods production.
Textiles: Various fabrics, including cotton, polyester, and felt, in an embodiment is cut with precision for textile-based projects.
Thin metals: With appropriate power settings, the system in an embodiment is capable of cutting or marking thin metals such as anodized aluminum or stainless steel.
Glass: While not suitable for cutting, the laser in an embodiment is used for etching or engraving glass surfaces.
Rubber: Both natural and synthetic rubber materials in an embodiment is cut and engraved, potentially useful for creating custom stamps or seals.
Foam: Various types of foam, including EVA and polyurethane, in an embodiment is processed for prototyping or packaging applications.

The material properties that influence compatibility with the system in an embodiment comprise any or all of the following:
Thickness: Materials up to 10 mm thick in an embodiment is cut, depending on their composition and the laser power settings.
Reflectivity: Materials with high reflectivity in an embodiment requires special considerations to ensure safe and effective laser processing.
Thermal properties: The material's melting point, vaporization temperature, and thermal conductivity in an embodiment affects the cutting and engraving process.
Composition: Materials free from harmful substances when vaporized in an embodiment is preferred for safety reasons.
Adhesive compatibility: The chosen materials in an embodiment are compatible with the adhesives used in the Adhesive Application System 400 to ensure proper bonding between layers.

The Vacuum Retention System 510 in this embodiment in an embodiment is designed to work with materials of varying surface textures and porosities. The suction force in an embodiment is adjustable to accommodate different material weights and properties, ensuring secure retention during the printing process.

By accommodating this wide range of materials in accordance with varying embodiments, the system in an embodiment is capable of producing diverse three-dimensional objects, potentially expanding its applications across various industries such as prototyping, manufacturing, and artistic endeavors.

Embodiments of the system comprise a ZY-Axis Frame 300. In various embodiments, the ZY-Axis Frame 300 comprises two vertical supports each attached at or near their lowest aspect to the Platform Base 100. The ZY-Axis Frame 300 further comprises a Y-Axis Crossbar 200 connecting the vertical-most aspects of each of the vertical supports.

Various aspects of the system and its associated methods comprise one or more stepper motors. In the preferred embodiment, the system comprises a Head Motor 512, one or more X-Axis Motors 105, one or more Y-Axis Motors 210, one or more Z-Axis Motors 305, and one or more Applicator System Motors. In the preferred embodiment, the one or more motors (excepting the Head Motor 512) each consist of 2 amp, NEMA 17 Stepper Motors. In the preferred embodiment, the NEMA 17 Stepper Motors are 2 amp motors with 200 steps per revolution. In various embodiments, each of the motors are driven by a central circuit board. Via the central circuit board and instructions programmed in association with various files (including command files) input into the system, the motors are commanded to ‘step’ a certain number of times.

In an embodiment of the invention, the system in an embodiment incorporates various motors for precise motion control and positioning. The preferred embodiment in an embodiment comprises a Head Motor 512, one or more X-Axis Motors 105, one or more Y-Axis Motors 210, one or more Z-Axis Motors 305, and one or more Applicator System Motors.

The motors in this embodiment, with the exception of the Head Motor 512, may consist of 2 amp, NEMA 17 Stepper Motors. These NEMA 17 Stepper Motors may be 2 amp motors with 200 steps per revolution, providing high precision in movement control. This level of precision in an embodiment allows for accurate positioning of the Laser-Vacuum Toolhead 500 and other system components.

In terms of control mechanisms, the motors in this embodiment are driven by a central circuit board. The central circuit board, in conjunction with instructions programmed in association with various files (including command files) input into the system, in an embodiment commands the motors to ‘step’ a certain number of times. This control method in an embodiment allows for precise and programmable movement of system components.

The integration of these motors within the system in an embodiment is designed to provide coordinated movement across multiple axes. For example, the Y-Axis Motor 210 in the preferred embodiment may drive the Laser-Vacuum Toolhead linearly to different locations along the Y-Axis Crossbar 200. This motor in an embodiment utilizes a toothed band to push and pull the Laser-Vacuum Toolhead 500 along the Y-Axis Crossbar in the programmed amount.

Similarly, the X-Axis Motors 105 in the preferred embodiment is configured to work in parallel to move the ZY-Axis Frame 300 evenly from opposing sides. These motors in an embodiment are mounted to the Platform Base 100 and use toothed bands to push and pull the ZY-Axis Frame 300 in the programmed amount.

The Z-Axis Motors 305 in this embodiment are mounted to the ZY-Axis Frame 300 and configured to relocate the Y-Axis Crossbar 200 vertically via the Vertical Actuator 220(s). Each Z-Axis Motor 305 in an embodiment is coupled to a Linear Screw 225 via a Coupler 227, allowing for precise vertical positioning of the Y-Axis Crossbar 200 and its attachments.

The system's precision in an embodiment is further enhanced by the motor control mechanisms. For instance, each step from the Z-Axis Motors 305 results in an embodiment in 0.02 mm of linear movement of the Y-Axis Crossbar 200 in the commanded direction, potentially allowing for very fine adjustments in the vertical positioning of system components.

The integration of these motors within the overall system in an embodiment allows for coordinated movement across all axes. For example, the system in an embodiment is configured to relocate the ZY-Axis Frame 300 to a designated location along the X-Axis, move the Laser-Vacuum Toolhead 500 to a desired Y-Axis position, and then adjust the Z-Axis position of the Y-Axis Crossbar 200. This coordinated movement in an embodiment enables the system to precisely position the Laser-Vacuum Toolhead 500, along with any Objects 1000 attached to its Suction Head 515, to a plurality of locations within the system as desired during use.

The control of these motors in an embodiment is further refined through the use of computer software and command files. The printerCtrl scripts in an embodiment converts data to collections of discrete points, which are then converted to movements of the stepper motors. The command files in an embodiment include additional configurations, such as setting each stepper motor's torque to a certain value, potentially allowing for fine-tuning of the system's performance based on the specific requirements of each printing job.

In an embodiment of the invention, the object design and slicing process in an embodiment is a critical component of the three-dimensional printing system. The system may utilize specialized computer software, such as Fusion 360 by Autodesk and associated plugins, to assist in the creation, manipulation, and storage of 3D models to be transferred to the printer.

The slicing algorithm in an embodiment is implemented through a “slicing and placement” script within the Fusion360 software package. This script generates outputs including a .dxf file and a .txt file, which may direct the controlling aspects of the system to specific locations where an Object 1000 should be picked by the vacuum laser head and subsequently placed at a point on or proximal to the Material Stacking Plane 120.

Layer thickness considerations in an embodiment are incorporated into the configuring the desired outcome step. During this step, parameters for the printer and materials may be set prior to the initiation of a particular project. These parameters may include the material to be utilized and the thickness of the material to be used in association with a particular project. This information may be input to the controlling aspects of the system via a JSON file for processing.

The system in this embodiment allows for flexibility in orienting the Object 1000 to be printed. The orientation may be designated via software and a user interface integrated within the system, or via software operating on an external computing device. This flexibility may allow users to optimize the object's orientation for factors such as structural integrity, material usage, or printing time.

Design constraints in this embodiment in an embodiment are influenced by various factors of the system. For instance, the usable applicator width associated with the Adhesive Application System 400 may be 890 mm, which may define the maximum cross-sectional length of layer cutout that can have adhesive applied completely across its surface. This constraint may need to be considered when designing objects to be printed by the system.

The printerCtrl suite of scripts associated with the Fusion 360 software package in an embodiment process the .dxf and .txt files to output a command file that can be loaded onto the controlling aspects of the system. This command file enables the operation of the system to print a desired Object 1000, potentially incorporating various design constraints and slicing parameters.

In terms of the slicing process, the system in an embodiment is designed to slice the Object 1000 into layers via computer processing. The script may rely upon the Fusion360 application program interface (API) to interact with the 3D model of the Object 1000 desired to be printed. The slicing process may involve determining where each of the layers can be picked up by the vacuum laser head from the Cutting Area 110, arranging each of the layers onto a sheet or in the Material Stacking Plane 120, and determining where each of the layers should be picked up and placed relative to a predetermined point.

The system in an embodiment also generates frames that match the size and location constraints of the Cutting Area 110 and Material Stacking Plane 120, and optionally their relative distances to one another. This feature may help ensure that the sliced layers fit within the physical constraints of the system.

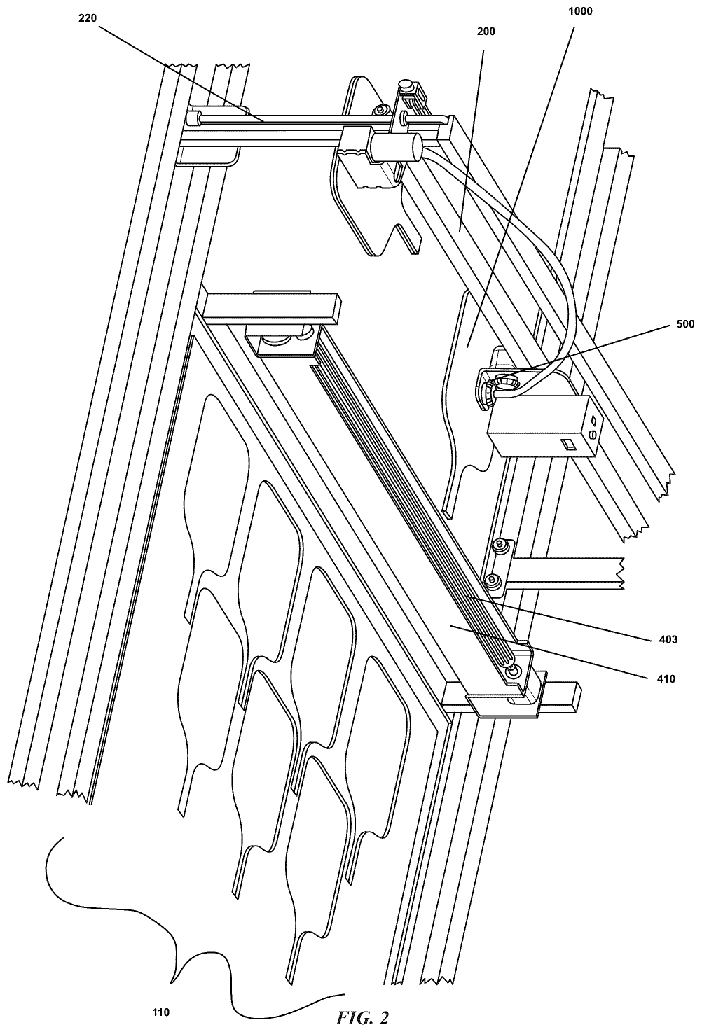

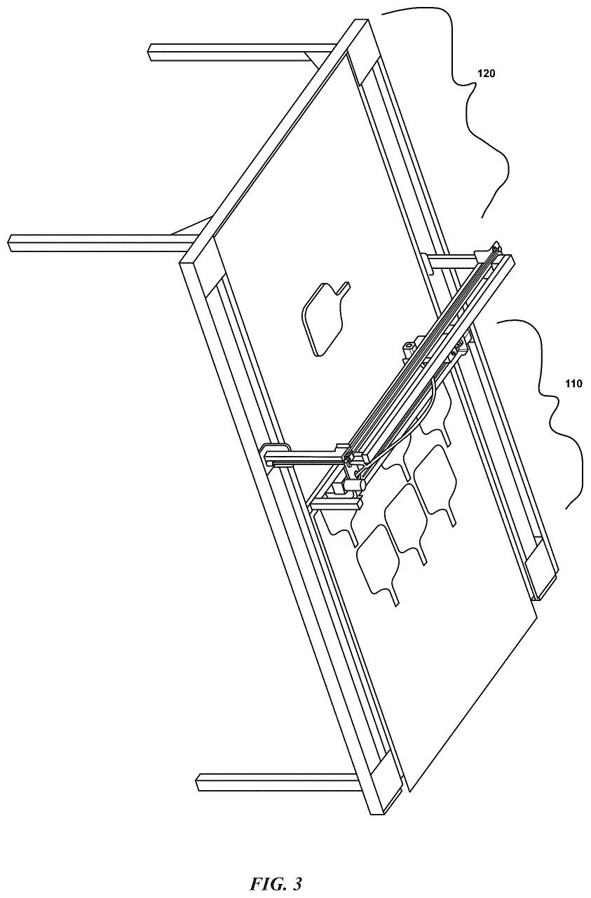

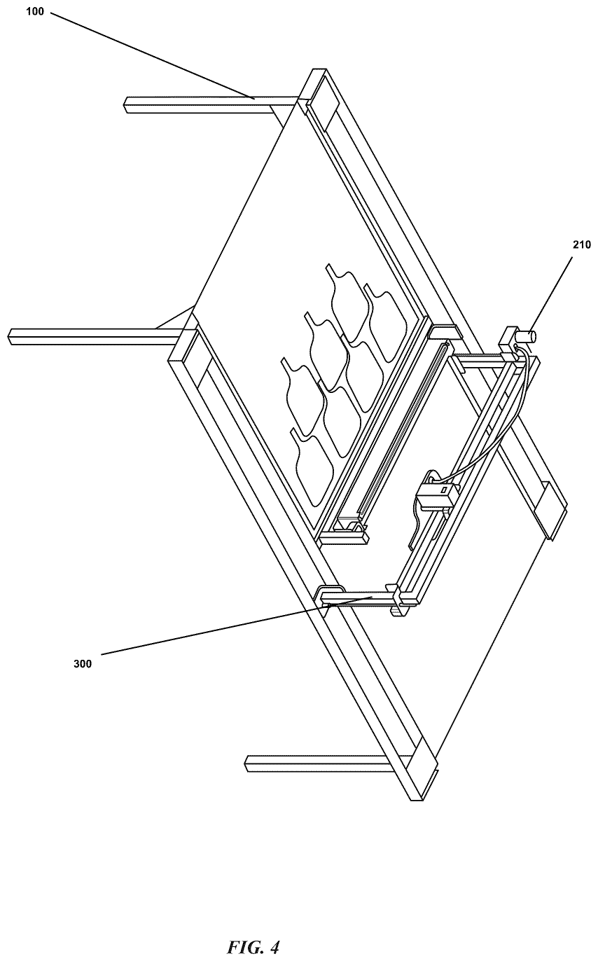

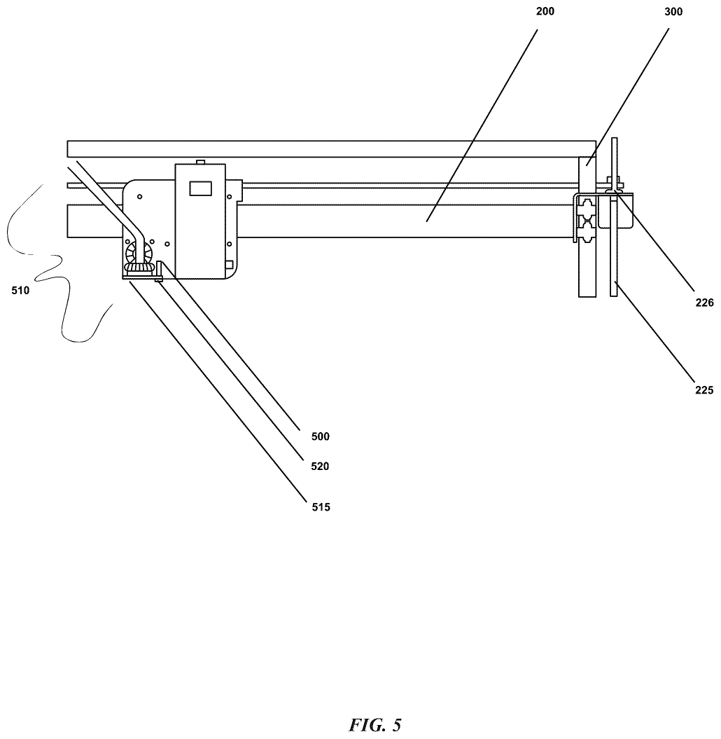

In an embodiment, the Laser-Vacuum Toolhead 500 comprises a Head Motor 512, as depicted in FIG. 2. In an exemplary use, the Head Motor 512 is utilized to rotate an Object 1000 while the Suction Head 515 of the Laser-Vacuum Toolhead 500 has picked up a layer. In the preferred embodiment, the Head Motor 512 consists of an off-the-shelf pump motor.

Various embodiments of the system comprises at least one Y-Axis Motor 210. The preferred embodiment comprises a single Y-Axis Motor 210. The Y-Axis Motor 210 in the preferred embodiment drives the Laser-Vacuum Toolhead linearly to different locations along the Y-Axis Crossbar 200. In the preferred embodiment, the Y-Axis Motor 210 is mounted on the Y-Axis Crossbar 200. In various embodiments, each Y-Axis Motor 210 in association with the other teachings of the system utilizes a toothed band to push and pull other aspects of the system along the Y axis. In the preferred embodiment, the Y-Axis Motor 210 pushes and pulls the Laser-Vacuum Toolhead 500 via a belt connecting the Laser-Vacuum Toolhead 500 and the Y-Axis Motor 210 along the Y Axis Crossbar in the programmed amount.

In various embodiments, the system comprises one or more X-Axis Motors 105. The preferred embodiment comprises two X-Axis Motors 105. These are configured in the preferred embodiment to work in parallel to move the ZY-Axis Frame 300 evenly from opposing sides. In the preferred embodiment, each X-Axis Motor is mounted to the Platform Base 100. In various embodiments, each X-Axis Motor in association with the other teachings of the system utilizes a toothed band to push and pull other aspects of the system along the X axis. In the preferred embodiment, the X Axis Motors are fixed to the Platform Base 100. In various embodiments, the X Axis Motors work together to push and pull the ZY-Axis Frame 300 via the toothed bands in the programmed amount. The ends of the toothed bands are fixed to the ZY-Axis Frame 300 to perform this action.

In the preferred embodiment, the system comprises one or more Z-Axis Motors 305. In the preferred embodiment, each of the Z-Axis Motors 305 are mounted to the ZY-Axis Frame 300 at a location proximal or slightly inferior to the tabletop area of the Platform Base 100. The one or more Z-Axis Motors 305 are configured to relocate the Y-Axis Crossbar 200 vertically via the Vertical Actuator 220(s).

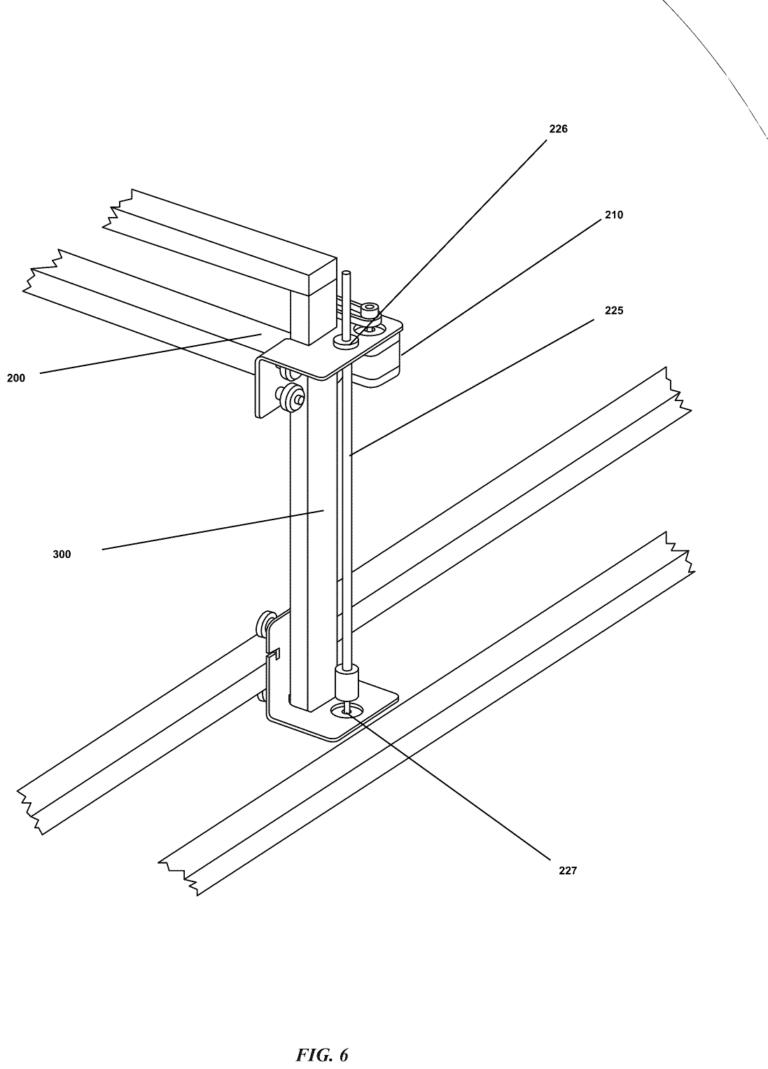

An embodiment of the system comprises a Vertical Actuator 220 as depicted by FIG. 6. In the preferred embodiment, the Vertical Actuator 220 comprises at least a Linear Screw 225, the Linear Screw Nut 226, and a Coupler 227. Each Coupler 227 is configured to enable the coupling of a Z-Axis Motor 305 to a Linear Screw 225. In various embodiments, the system may comprise a plurality of Vertical Actuators 220 configured to function in tandem to evenly raise or lower the Y-Axis Crossbar 200 along the ZY-Axis Frame 300. The preferred embodiment comprises two Z Axis Motors; one on either side of the ZY-Axis Frame 300. In such embodiment, each Z Axis Motor 305 has its own screw to lift and lower the Y-Axis Crossbar 200 (and other aspects of the system attached to the Y-Axis Crossbar 200) from both sides. In an embodiment, a 5 mm motor shaft associated with the Z Axis Motor 305 is coupled to the Linear Screw 225, comprising a 8 mm screw, via a Coupler 227 comprising a 5 mm to 8 mm flexible coupler. In association with an intended method of operation, the Z-Axis Motors 305 are commanded to ‘step’ a certain number of times (if there are multiple Z-Axis Motors 305, the motors are commanded to step in tandem) to rotate the Linear Scres and thus translate the Y-Axis Crossbar 200 (and its attachments, optionally including the Laser-Vaccum Toolhead) up and down a desired amount. Each step from the the one or more Z-Axis Motors 305 results in 0.02 mm of linear movement of the Y-Axis Crossbar 200 in the commanded direction.

In the preferred embodiment, each Z-Axis Motor 305 operating in coordination with a Vertical Actuator 220 is intended to move the Y-Axis Crossbar 200 up and down. In this way, aspects of the system connected to the Y-Axis Crossbar 200 may relocate vertically. During an exemplary use, the system may be configured to relocate the ZY-Axis Frame 300 to a designated location along the X-Axis by commands to the one or more X-Axis Motors 105 which connect to the ZY-Axis Frame 300 via one or more toothed bands, to relocate the Laser-Vacuum Toolhead 500 to a desired Y-Axis position along the Y-Axis Crossbar 200 by commands to the Y-Axis Motors 210 which connect to aspects of the Laser-Vacuum Toolhead 500 via one or more toothed bands, and then relocate the Y-Axis Crossbar 200 to a designated Z-Axis position via the one or more Z-Axis Motors 305 each linked to aspects of the Y-Axis Crossbar 200 via a Linear Screw 225. In such way, the system functions to relocate the Laser-Vacuum Toolhead 500, along with any Object 1000s attached to its Suction Head 515, to a plurality of locations associated with the system as desired during use as intended by the inventor.

In an exemplary use, the commands transmitted to the computer software aspects of the system cause the one or more stepper motors to move. As will be appreciated by those skilled in the art and described elsewhere herein, in an exemplary use the printerCtrl scripts convert data to collections of discrete points. After this is implemented, in an exemplary use the printerCtrl scripts take these discrete points and convert them to movements of the one or more stepper motors. As will be recognized by those skilled in the art, stepper motors move in discrete steps. In an exemplary use, the first pair of numbers relates to the X-Axis Motors 105. In an exemplary use, the first number in the pair is whether that given motor will be stepped. If the number is 1, then the motor will be commanded to step. If the motor is 0, that motor will remain stationary for that command. In an exemplary use, the second number is what direction the motor should step; either clockwise or counter clockwise for 1 or 0. In various embodiments, the one or more stepper motors may be further configured. For example, commands may be included within the various configuration files or elsewhere to set each of the stepper motor's torque to a certain value. These auxiliary commands are typically set at the beginning of the command file. As will be appreciated by those skilled in the art, each command file is saved to an SD card. Embodiments of the system may comprise a SD card reader configured to retrieve instructions from the SD card placed therein. In other embodiments, the configuration instructions may be transmitted wirelessly, via wired connection, or via other media (for example, a flash drive). When the printer is enabled, the printer reads this command file and executes the commands in sequential order. In an embodiment, the command file is ASCII encoded. In various embodiments, the command file is binary encoded, which the present inventor has recognized may improve file read speed from the media.

Various embodiments of the invention comprise a Laser-Vacuum Toolhead 500. In the preferred embodiment, the Laser Cutting System 520 and the Vacuum are co-located within the Laser-Vacuum Toolhead 500. In an embodiment, the Laser-Vacuum Toolhead 500 further comprises a Head Motor 512. During an exemplary use, as depicted in Fig. X, the Head Motor 512 is configured to rotate an Object 1000 once the Suction Head 515 of the Vacuum Retention System 510 has retrieved an Object 1000.

Embodiments of the invention comprise a Vacuum Retention System 510. In the preferred embodiment, the Vacuum Retention System 510 comprises a Suction Head 515. As explained elsewhere in the specification, in the preferred embodiment of the system, the Suction Head 515 is configured programmatically to retrieve each of the layers at a specific location of the layer. In various embodiments, the Suction Head 515 is located at a distal aspect of the Laser-Vacuum Toolhead 500, such that the vacuum force generated by the aspects of the Vacuum Retention System 510 can apply to an external Objects 1000 to retain it to the Laser-Vacuum Toolhead 500 as it relocates to various aspects of the system. The Vacuum Retention System 510 further comprises a Vacuum Pump. In the preferred embodiment, The Vacuum Pump is affixed to the Y-Axis Crossbar 200 on the side of the Y-Axis Crossbar 200 opposite from the Y-Axis Motor 210. Suction is applied to the Suction Head 515 via a tube connecting the Suction Head 515 to an input aspect of the Vacuum Pump. As the Y-Axis Motor 210 pushes and pulls the Laser-Vacuum Toolhead in the preferred embodiment, the Vacuum Pum remains stationary, and the tube moves with the Laser-Vacuum Toolhead. In the preferred embodiment, the Vacuum Pump comprises a dry vacuum pump, capable of generating and maintaining suction in a gas medium.

The pump should be a ‘dry’ vacuum pump, i.e. a pump capable of generating and maintaining suction in a gas medium. The Vacuum Retention System 510 utilizes suction generated via the Vacuum Pump to retrieve a portion of material from the Cutting Area 110 and hold it against the Suction Head 515 and retain a portion of the material during actuation of a plurality of motors to enable the movement of the Laser-Vacuum Toolhead 500, optionally along the side retention arms and crossbar arm of the system.

In an embodiment of the invention, the Vacuum Retention System 510 in an embodiment comprises a Suction Head 515 and a Vacuum Pump. The Suction Head 515 in an embodiment is located at a distal aspect of the Laser-Vacuum Toolhead 500, potentially allowing the vacuum force generated by the Vacuum Retention System 510 to apply to external Objects 1000 for retention during relocation to various aspects of the system.

In this embodiment, the Vacuum Pump in an embodiment is affixed to the Y-Axis Crossbar 200 on the side opposite from the Y-Axis Motor 210. Suction may be applied to the Suction Head 515 via a tube connecting the Suction Head 515 to an input aspect of the Vacuum Pump. As the Y-Axis Motor 210 pushes and pulls the Laser-Vacuum Toolhead, the Vacuum Pump may remain stationary, while the tube moves with the Laser-Vacuum Toolhead.

The Vacuum Pump in this embodiment comprises a dry vacuum pump, capable of generating and maintaining suction in a gas medium. This configuration allows the Vacuum Retention System 510 to utilize suction to retrieve a portion of material from the Cutting Area 110 and hold it against the Suction Head 515, retaining the material during actuation of a plurality of motors to enable movement of the Laser-Vacuum Toolhead 500.

In an embodiment, the suction force generated by the Vacuum Retention System 510 in an embodiment is sufficient to retain various materials, including but not limited to wood, acrylic, and certain types of plastics, which are compatible with the Laser Cutting System 520. The suction force in an embodiment is adjustable to accommodate different material weights and surface properties.

The Vacuum Retention System 510 in this embodiment in an embodiment is designed to interact with different materials by maintaining a consistent seal between the Suction Head 515 and the surface of the material. This in an embodiment is achieved through the use of a flexible sealing material around the perimeter of the Suction Head 515, allowing it to conform to slight surface irregularities.

In an embodiment, the Vacuum Retention System 510 in an embodiment is integrated with the overall control system of the three-dimensional printer. This integration may allow for precise control of the suction force and timing, coordinating with the movements of the Laser-Vacuum Toolhead 500 and other system components. The system in an embodiment is programmed to activate and deactivate the vacuum at specific points during the printing process, such as when picking up a cut piece from the Cutting Area 110 or releasing it at the Material Stacking Plane 120.

Embodiments of the invention comprise a Laser Cutting System 520. The preferred embodiment of the Laser Cutting System 520 comprises a Laser configured to cut or burn through material. In the preferred embodiment, the Laser consists of a 450 nm, 30 W diode laser with fan cooling. It is powered by 24V and is controlled by a PWM signal. In an embodiment, the laser focus length of the Laser is configured programmatically. In an embodiment, the laser focus length is configurable mechanically using a lever or dial located on the side of the Laser-Vacuum Toolhead 500.

In an embodiment of the invention, the Laser Cutting System 520 in an embodiment comprises a high-powered diode laser designed for precision cutting and engraving. The laser in this embodiment may operate at a wavelength of 450 nm, falling within the visible blue light spectrum. This wavelength in an embodiment is particularly effective for cutting and engraving a wide range of materials, including wood, acrylic, and certain types of plastics.

In an embodiment, the laser's power output in an embodiment is rated at 30 W, potentially providing sufficient energy for cutting through materials up to 10 mm thick, depending on the specific material properties. This power level in an embodiment allow for rapid cutting speeds while maintaining precision, with typical cutting speeds potentially ranging from 10-100 mm/second depending on the material and desired cut quality.

To ensure optimal performance and longevity in an embodiment, the Laser Cutting System 520 in an embodiment incorporates a fan cooling mechanism. This cooling system may help maintain a stable operating temperature for the laser diode, which could be crucial for consistent output power and wavelength stability. The fan cooling may also allow for extended operation times without the risk of overheating.

In an embodiment, the laser focus length in an embodiment is a critical parameter that can be adjusted to optimize cutting performance for different material thicknesses. The focus length in an embodiment is adjustable either programmatically through the system's software interface or manually using a lever or dial located on the side of the Laser-Vacuum Toolhead 500. This flexibility in an embodiment allows users to fine-tune the laser focus for different materials and cutting requirements.

In an embodiment, the Laser Cutting System 520 in an embodiment is powered by a 24V DC power supply, which could provide stable and efficient power delivery to the laser diode. The laser's output in an embodiment is controlled via a Pulse Width Modulation (PWM) signal, potentially allowing for precise control of the laser power during cutting operations. This PWM control may enable the system to adjust laser intensity on-the-fly, facilitating variable depth cutting and engraving capabilities.

In terms of cutting capabilities in an embodiment, the Laser Cutting System 520 in an embodiment is designed to perform a variety of operations, such as straight line cutting, curve and complex shape cutting, engraving, marking, and perforation. The system may be able to make precise straight cuts through materials, with a typical kerf width of 0.1-0.3 mm depending on the material and laser settings. It in an embodiment is capable of following intricate paths to cut out complex shapes and designs, with a minimum radius of curvature of approximately 0.5 mm. By modulating the laser power and speed, the system in an embodiment creates detailed engravings on the surface of materials, with a typical resolution of up to 1000 DPI. The laser in an embodiment is usable to create high-contrast marks on various materials for identification or decorative purposes, and create precise perforations in materials, useful for creating tear lines or ventilation in packaging applications.

In an embodiment, the Laser Cutting System 520 in an embodiment is integrated with the overall control system of the three-dimensional printer, potentially allowing for seamless coordination between the laser cutting operations and the other components of the system, such as the Vacuum Retention System 510 and the material handling mechanisms.

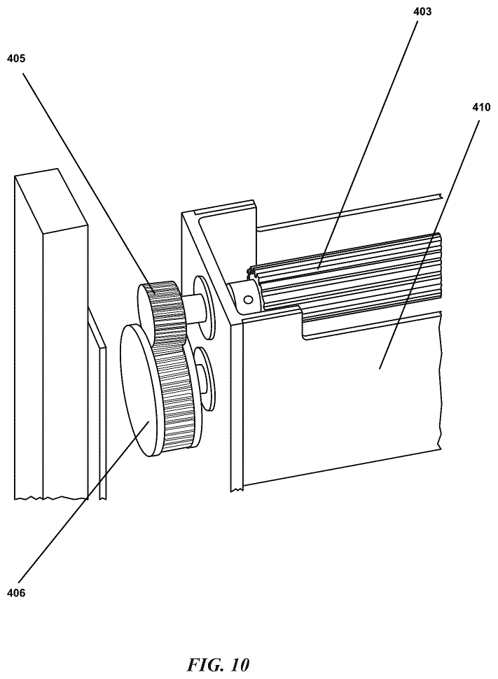

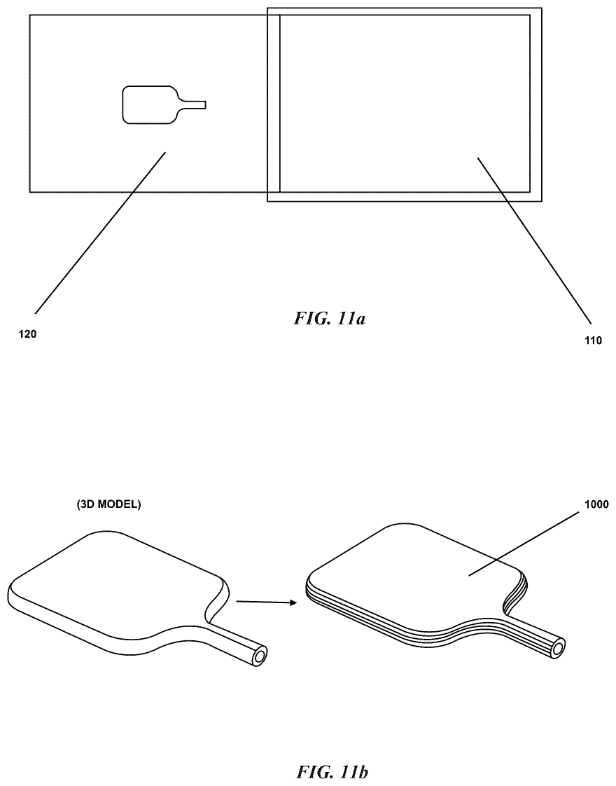

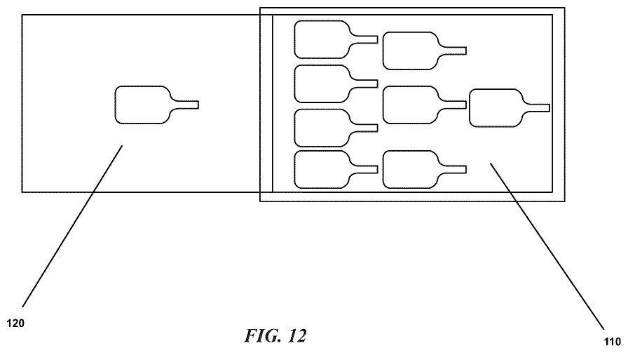

Embodiments of the invention comprise an Adhesive Application System 400. The Adhesive Application System 400 comprises an Adhesive Tray 410 and an Upper Roller 403 and Lower Roller 404. In various embodiments the length and width dimensions of the Adhesive Tray 410 exceed the length and width dimensions of the Lower Roller 404. In this way, the Lower Roller 404 may partially or fully fit within the interior volume of the Adhesive Tray 410. In embodiments of the invention, the interior volume of the Adhesive Tray 410 is at least partially filled with adhesive. The adhesive foreseen by the inventor for utilization with various embodiments may comprise any liquid based adhesive compatible for use with roller-type applicators as is readily understood by those skilled in the art. In various embodiments, the adhesive comprises a liquid or viscous solution that will not cure while housed in the Adhesive Application System 400 during its use, but will bond layers of material together when applied by the Adhesive Application System 400 in the stacking of layers by the Laser-Vacuum Toolhead 500. In various embodiments, the adhesives may include water based adhesives that adhere with exposure to air or evaporation, adhesives that require heat to cure and bond, and adhesives that will bond over a long period of time, such as 24 hour bonding adhesives. In the preferred embodiment, the adhesive consists of a general purpose water based adhesive. In an embodiment, the Upper Roller 403 is grooved and the Lower Roller 404 is smooth. In such configuration, an aspect of the Lower Roller 404 is consistently in contact with the adhesive placed within the Adhesive Tray 410, and an aspect of the Lower Roller 404 maintains contact with or is proximal to the Upper Roller 403 such that the adhesive is transferred from within the volume of the tray to the smooth surface of the Lower Roller 404, to at least the outer aspects of the grooved surface of the Upper Roller 403. In the preferred embodiment, the bottom roller is suspended fully within the Adhesive Tray 410. In association with teachings of the invention, the Lower Roller 404 is configured to provide a supply of adhesive at a generally constant thickness to the Upper Roller 403. During the preferred method of use, a transferring the adhesive step is performed whereby the Lower Roller 404 applies adhesive from the Adhesive Tray 410 to the Upper Roller 403's flanges at the point where the two rollers are on top of each other. Then, rows of adhesive will be transferred to the underside of any Object 1000 that grazes the Upper Roller 403's flanges while retained by the Vacuum Retention System 510 and prior to being transferred to or proximal to the Material Stacking Plane 120. In an embodiment, the Adhesive Application System 400 further comprises an Adhesive Motor. The Adhesive Motor is attached to one of the ends of the Upper Roller 403. The opposite end of the Upper Roller 403 features a gear configured to interact with a corresponding gear of the Lower Roller 404, thus transferring movement to the Lower Roller 404, as depicted in FIG. 10. In the preferred embodiment, the usable applicator width associated with the Adhesive Application System 400 is 890 mm, which defines the max cross-sectional length of layer cutout that can have adhesive applied completely across its surface.

In an embodiment of the invention, the Adhesive Application System 400 in an embodiment comprises an Adhesive Tray 410, an Upper Roller 403, and a Lower Roller 404. The Adhesive Tray 410 may have length and width dimensions that exceed those of the Lower Roller 404, potentially allowing the Lower Roller 404 to partially or fully fit within the interior volume of the Adhesive Tray 410.

In this embodiment, the interior volume of the Adhesive Tray 410 in an embodiment is at least partially filled with adhesive. The adhesive foreseen for utilization with various embodiments may comprise any liquid-based adhesive compatible for use with roller-type applicators. The adhesive may be a liquid or viscous solution that will not cure while housed in the Adhesive Application System 400 during its use, but will bond layers of material together when applied by the Adhesive Application System 400 in the stacking of layers by the Laser-Vacuum Toolhead 500.

Various types of adhesives are compatible with the system in this embodiment. These may include water-based adhesives that adhere with exposure to air or evaporation, adhesives that require heat to cure and bond, and adhesives that will bond over a longer period of time, such as 24-hour bonding adhesives. In the preferred embodiment, the adhesive may consist of a general-purpose water-based adhesive.

Regarding adhesive curing methods, the system in an embodiment is be designed to accommodate various curing processes. For water-based adhesives, the curing may occur naturally through air exposure or evaporation. For heat-cured adhesives, the system may potentially incorporate a heating element or utilize the heat generated by the laser cutting process to facilitate curing. For longer-curing adhesives, the system may be designed to allow for appropriate curing time between layer applications.

In terms of application precision, the Adhesive Application System 400 in an embodiment is designed to provide consistent and controlled adhesive application. The Upper Roller 403 may be grooved while the Lower Roller 404 may be smooth. This configuration may allow an aspect of the Lower Roller 404 to be consistently in contact with the adhesive placed within the Adhesive Tray 410, while maintaining contact with or proximity to the Upper Roller 403. This arrangement may facilitate the transfer of adhesive from within the volume of the tray to the smooth surface of the Lower Roller 404, and then to the outer aspects of the grooved surface of the Upper Roller 403.

In the preferred embodiment, the usable applicator width associated with the Adhesive Application System 400 in an embodiment is 890 mm, which defines the maximum cross-sectional length of layer cutout that can have adhesive applied completely across its surface. This aspect in an embodiment is intended to ensure consistent adhesive coverage across the width of the material.

The Adhesive Application System 400 in an embodiment may further comprise an Adhesive Motor attached to one end of the Upper Roller 403. The opposite end of the Upper Roller 403 features in an embodiment a gear configured to interact with a corresponding gear of the Lower Roller 404, thus transferring movement to the Lower Roller 404. This motorized system may allow for precise control of adhesive application, potentially enabling adjustments to adhesive thickness and application speed to suit different materials and adhesive types.

In an embodiment of the invention, the system's scalability in an embodiment is addressed through various aspects of its design and operation. The system's ability to handle different sizes of objects or production volumes could potentially be enhanced by the following features:

The Platform Base 100 in the preferred embodiment is described as 2420 mm long by 1540 mm wide, and 1180 mm tall, with the Cutting Area 110 being approximately one square meter. This substantial size may allow for the production of relatively large objects, while also providing flexibility for scaling down to smaller objects as needed.

The system's modular design, incorporating separate components such as the Laser-Vacuum Toolhead 500, Adhesive Application System 400, and Material Stacking Plane 120, may allow for potential modifications or replacements to accommodate different production requirements. For instance, the Laser Cutting System 520 could potentially be upgraded or replaced with a more powerful laser for larger or denser materials, or a less powerful one for smaller, more delicate objects.

The Adhesive Application System 400's usable applicator width of 890 mm in an embodiment defines the maximum cross-sectional length of layer cutout that can have adhesive applied completely across its surface. This width could potentially be increased or decreased in different embodiments to accommodate larger or smaller objects, respectively.

The system's software integration, particularly its use of Fusion 360 and associated scripts, in an embodiment allows for scalability in terms of object design and slicing. The software could potentially be adapted to handle larger or more complex designs, or to optimize for different production volumes.

The use of stepper motors (NEMA 17 Stepper Motors with 200 steps per revolution) for precise movement control in an embodiment allows for scalability in terms of precision.

For larger objects or higher production volumes, in an embodiment more powerful motors are incorporated without significant changes to the overall system architecture.

The system's ability to work with a wide range of materials of varying thicknesses (up to 10 mm) contribute to its scalability in accordance with embodiments, allowing for the production of objects with different sizes and complexities.

The Vacuum Retention System 510's adjustable suction force may allow it to handle materials of different weights and properties, potentially contributing to the system's ability to scale for different object sizes.

In an embodiment, the system's modular design and software-driven operation in an embodiment potentially allow for the incorporation of multiple units working in parallel for increased production volumes. This in an embodiment involves multiple Laser-Vacuum Toolheads 500 operating simultaneously on a larger Platform Base 100, or even multiple complete systems working in coordination.

### Exemplary Methods of Use

Exemplary methods of use of the Laser Cutting System 520 are performed in accordance with some or all of the following steps:

A method of operation of the system comprises the configuring a desired outcome step. During this configuring the desired outcome step, the parameters for the printer and materials utilized for the printer are set prior to the initiation of a particular project by the system. In an embodiment, the configuring the desired outcome step may further comprise an inputting the configuration step. It will be appreciated by those skilled in the art that various aspects of the system, including aspects of this step, operate with assistance of specialized computer software. In various embodiments, it is appreciated that the software associated with 3D modeling is highly assistive in the operation of the systems and its associated methods and steps. One of the leading such software platforms useful in association with the creation, manipulation and storage of 3D models to be transferred to 3D printers is Fusion 360 by Autodesk, and optionally various other related software packages and plugins. During the inputting the configuration step, this is input to the controlling aspects of the system (such as various computer hardware configured to operate the system) via a JSON file for processing by the controlling aspects of the system. The parameters in an embodiment comprise the printer bed size, the material to be utilized in association with a particular project, and the thickness of the material to be utilized in association with a particular project. The configuring the desired outcome step may further comprise an opening of the model of an Object 1000 to be printed. In an embodiment, the model is opened via Fusion 360. The configuring the desired outcome step may further comprise an orienting the Object 1000 step. During the orienting the Object 1000 step, the orientation of the Object 1000 to be printed is chosen. The orientation may be designated via software and a user interface integrated within the system, or via software operating on an external computing device. The configuring the desired outcome step may further comprise slicing and placing the Object 1000 step in association with computer software. The slicing and placing the Object 1000 step may further comprise running the “slicing and placement” script in the Fusion360 software package. The outputs of the script may include a .dxf file and a .txt file which those skilled in the art would appreciate direct the controlling aspects of the system of the specific locations associated with which locations an Object 1000 should be picked by the vacuum laser head of the system and subsequently placed at a point on or proximal to the Material Stacking Plane 120. The .dxf file and the .txt file may subsequently be processed by the printerCtrl suite of scripts associated with the Fusion 360 software package to output a command file that can be loaded onto the controlling aspects of the system to enable the operation of the system to print a desired Object 1000.

A method of operation of the system comprises the placing material step. During this step, the material desired to be cut by the Laser Cutting System 520 is placed in or proximal to the Cutting Area 110 of the system. The material chosen in various embodiments during this step matches the characteristics of the material as designated during the configuring the desired outcome step. In an embodiment, the controlling aspects of the system are preconfigured to match the width and length of the Cutting Area 110 of the system. In various embodiments, the preconfigured width and length of the system matches visual cues that are etched or otherwise labeled within the Cutting Area 110. In an embodiment, the length and width of the Cutting Area 110 and Material Stacking Plane 120 are designated via a JSON file accessible to the controlling aspects of the system for processing by the controlling aspects of the system. In various embodiments, the system can be configured to accept a sizing and placement of material to match wherever it is placed within the Cutting Area 110.

A method of operation of the system comprises the activating a laser step. In the preferred embodiment, the laser provided within the Laser-Vacuum Toolhead 500 consists of a 450 nm, 30 W diode laser. In various embodiments, the Laser-Vacuum Toolhead 500 further comprises fan cooling, which is contemporaneously activated when the laser is activated during this step. In various embodiments, the laser is powered by a 24V DC electricity source. In an embodiment the laser focus length is configurable by a lever located proximal to the laser or placed on other aspects of the system. In an embodiment, the laser focus length is controlled programmatically by the controlling aspects of the system.

A method of operation of the system comprises the relocating the laser along a preconfigured path step. In association with various aspects of the system, Fusion360 and its associated aspects and scripts are utilized to transfer instructions via a command file to the laser and its associated aspects to cut the material placed within the Cutting Area 110 along a predefined path. In an exemplary use, when the Laser-Vacuum Toolhead 500 is following a collection of points from the .DXF file, it knows it is tracing a layer and will enable the laser at the programmed setting before writing motor step commands. The computer software aspects of the system are configured to act upon commands to move the Laser-Vacuum Toolhead 500 so that the laser output is the piece of the toolhead that is following these programmed outputs.

In various embodiments, the relocation of the Laser-Vacuum Toolhead 500 is accomplished by a plurality of stepper motors, optionally including any of the one or more X-Axis Motors 105, the one or more Y-Axis Motors 210, the one or more Z-Axis Motors 305, and the Head Motor 512, working in coordination as directed by the computer software aspects of the system. As described elsewhere herein, the coordinates associated with the system may be presented in the (0, 0, 0) format, where the (0, 0, 0) location is associated with a physical reference point within the system. In an example, the first number in such format corresponds with the quantity of units away from the reference point X axis, and thus signifies whether the Laser-Vacuum Toolhead 500 will move or not during a presented command. In an exemplary use, thousands of motor control commands as described elsewhere herein are strung together in the command file to produce the complete movements of the aspects of the system.

In an embodiment the script relies upon the Fusion360 application program interface (API) to interact with the 3D model of the Object 1000 desired to be printed. In exemplary relocating the laser along a preconfigured path step, the step comprises slicing the Object 1000 into layers via computer processing, transferring instructions to slice the Object 1000 into layers via activation of the laser of the Vacuum-Laser Toolhead 500, determining where each of the layers can be picked up by the vacuum laser head from the Cutting Area 110, arranging each of the layers onto a sheet or in the Material Stacking Plane 120, and determining where each of the layers should be picked up and placed relative to a predetermined point, generating frames that match the size and location constraints of the Cutting Area 110 and Material Stacking Plane 120, and optionally their relative distances to one another. It will appreciated by those skilled in the art that the above steps can be accomplished in association with a script operating in association with computer software in communication with various aspects of the system.

In various embodiments and methods associated with the invention, the specific instructions for the retrieval of sliced layers in the Cutting Area 110 and the placement of such layers within or proximal to the Material Stacking Plane 120, are configured as a. JSON file. In various embodiments, the printer will begin moving the toolhead along paths and outlining shapes as defined in a .DXF file. In an exemplary use, the printerCtrl scripts convert the DXF file data to series of discrete points that outline the shapes and lines defined in the DXF file. From one point to the next, the printerCtrl scripts calculate how many steps must occur in the X, Y and Z directions for the Laser-Vacuum Toolhead 500 to reach that point. In various embodiments, the instructions and characterization of Objects 1000 as one or more models achieves the objective of providing coordinates for retrieval and placement at designated locations relative to a predetermined location within the system. As a result of such configuration, the present inventor has recognized that the Object's 1000 layers may be arranged, while the retrieval and placement locations can be determined in a software/virtual environment, while the locations within the software/virtual environment correspond to relative locations within the physical aspects of the system itself. It should be appreciated in association with the present invention that the term Object 1000 may refer to a fully or partially completed Object 1000 located within the Material Stacking Plane 120 following the stacking of other component Objects 1000 that have been cut out of material placed within the Cutting Area 110. Alternatively, the term Object 1000 may refer to any item collected from the Cutting Area 120 via the Suction Head 515 and in transit from the Cutting Area 110 to the Material Stacking Plane 120. Further, the present inventor recognizes the importance of pre-configuration of the dimensions of the system's physical regions (including the Material Stacking Plane 120 and the Cutting Area 110), which in the preferred embodiment is placed within a .JSON configuration file and made accessible to other software aspects of the system as will be appreciated by those skilled in the art.

In the preferred embodiment, the instructions associated with the relocating the laser along a preconfigured path step are encoded and translated for the vacuum laser head to move along the side retention arms and crossbar arm of the system. In the preferred embodiment, one or more stepper motors are located strategically within the system to translate the .JSON instructions to mechanical movement. In various embodiments, the instructions to activate the one or more stepper motor(s) are processed by the computer software and computer hardware aspects of the system to relocate the Laser-Vacuum Toolhead 500 as desired within the physical aspects of the system. Similarly, in various embodiments, the instructions to activate the laser cutter are processed by the computer software and computer hardware aspects of the system while the Laser-Vacuum Toolhead 500 is relocated along a predefined path relative to a layer of physical material to cut the material as desired in association with relocating the laser along a preconfigured path step.

A method of operation of the system comprises repeating the relocating of the laser along a preconfigured path step for subsequent layers. In various embodiments of the invention the repeating step is performed numerous times. During the repeating step, a layer is cut from a different area of the sheet of material. In an embodiment, during or prior to the repeating the relocating the laser along a preconfigured path step, the method further comprises preparing to arrange the layers step. In an exemplary preparing step, a script associated with the computer software aspects of the system prepares to arrange the layers onto the sheet in the Cutting Area 110. The instructions to create a layer during each repeating step comprise different paths resulting in layers that may not be identical to previously generated or subsequent layers during the printing of an Object 1000 in association with aspects of the system.

A method of operation of the system comprises identifying the optimal point of vacuum contact for each layer. In various embodiments, the computer software optimizes the material utilized and the order by which each layer is cut to maximize efficiencies. In the preferred embodiment, a script associated with the computer software aspects of the system identifies a location on each of the layers, optionally the center of the layer, that does not enclose or overlap any empty space, as the target for the Laser-Vacuum Toolhead 500 to relocated to for activation of the vacuum aspects of the system for retrieval of the layer. The present inventor has recognized the importance that the target location for the Vacuum Retention System 510 during Laser-Vacuum Toolhead 500 retrieval must not encompass any empty space, otherwise the vacuum may not function optimally to retrieve the layer. The present inventor has recognized that not all shapes can be picked up from the center of the layer if there happens to be any empty space at the center of the layer. An example of this would be a ring shape. The present inventor has further recognized that any empty space could compromise the seal of the Suction Head 515 of the during retrieval of the physical layer. In alternative examples, if a layer cannot be picked up from the center, the script in association with the preferred method of use is configured to search for a new location to retrieve the layer by activation of the vacuum by radially testing new locations around the center of the layer. During such exemplary step, the script may progressively seek locations farther and farther away from the center of the layer until a location is found where a circle representing the outer diameter of the Suction Head 515 of the vacuum does not enclose any empty space.

Following actuation of the stepper motors to relocate the Laser-Vacuum Toolhead 500 from a location proximal to the Cutting Area 110 to the desired location proximal to the Material Stacking Plane 120, a deactivating the vacuum step is performed, during which the Vacuum Retention System 510 is deactivated to allow for separation of the layer from the Suction Head 515. It is a teaching of the invention to deactivate the Vacuum Retention System 510, and facilitate the separation of the layer from the Suction Head 515, upon relocation of the Laser-Vacuum Toolhead 500 to the location where the layer is aligned as desired proximal to the Material Stacking Plane 120, optionally additionally in relation to previously placed layers. At this point, methods associated with the system further comprise the deactivating the Vacuum Retention System 510 step, to facilitate release of the layer. During an exemplary use, after the .DXF file's data is used to program the command file to cut the layers, the printerCtrl script moves to the pick and place file. Since the scripts know that it is reading the pick and place file, the computer software aspects of the system in an embodiment now act upon commands to move the toolhead relative to the Suction Head 515, instead of the probe or laser. When aspects of the system directed to follow points from the pick and place file, the computer software aspects of the systems will generate a command to enable the pump of the Vacuum Retention System 510 once the location of an Object 1000 desired to be retrieved from within the Cutting Area 110 is reached.

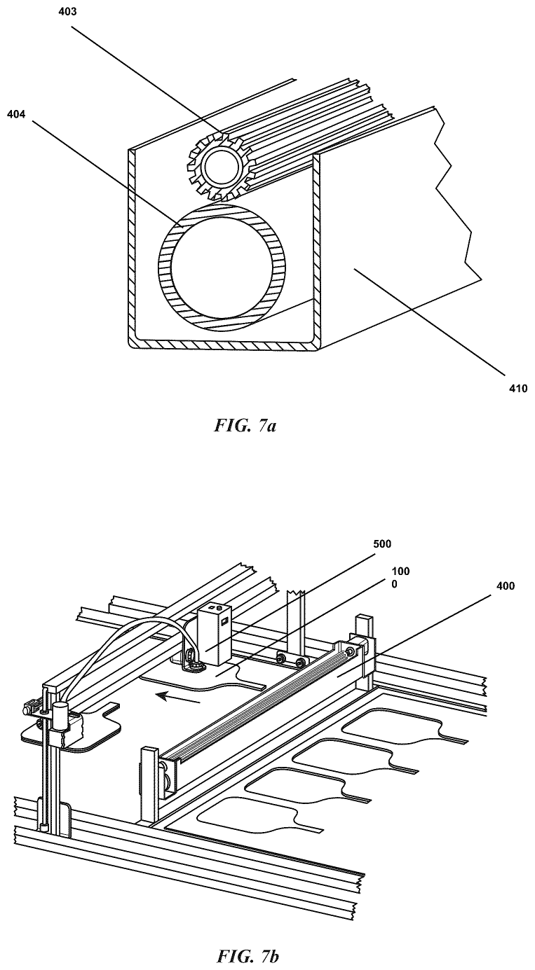

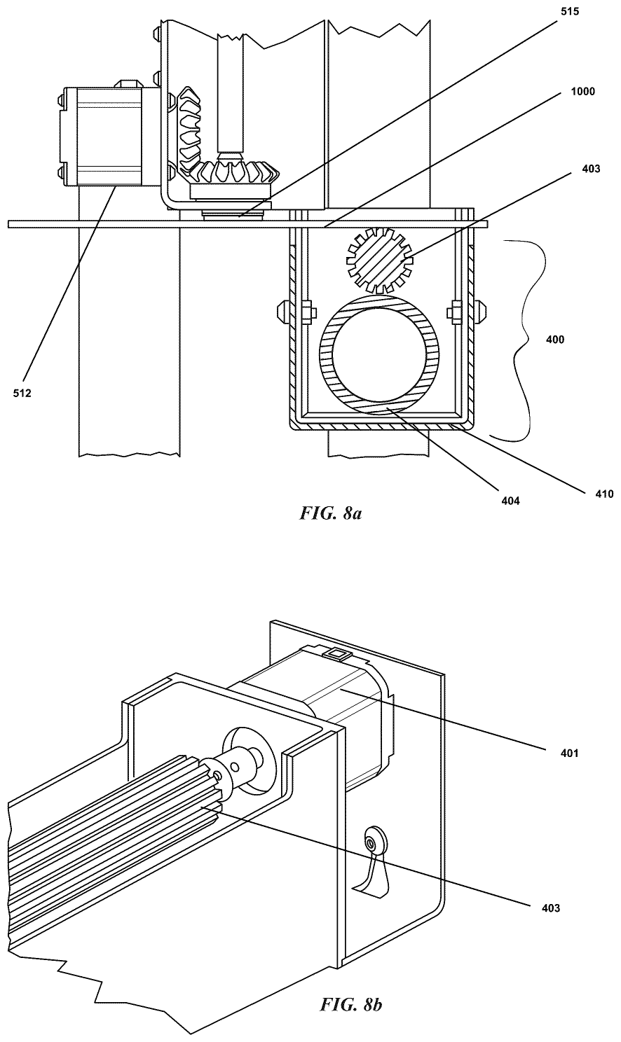

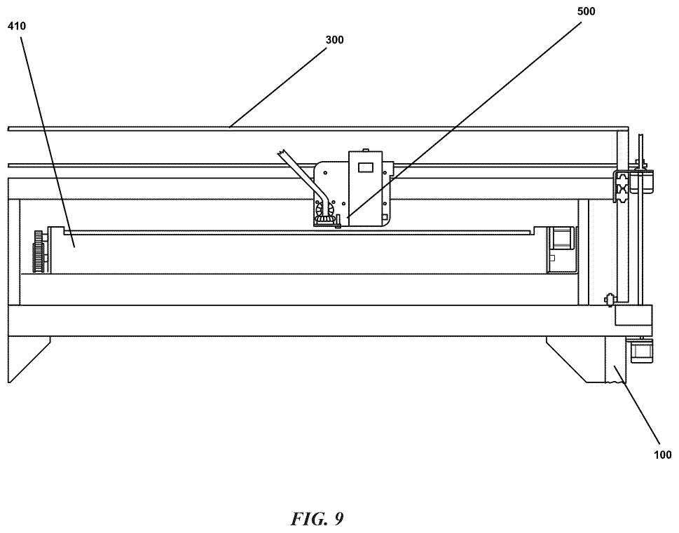

In association with an intended method of use, once the location of an Object 1000 in or adjacent to the Cutting Area 110 is reached, then the Head Motor 512 is enabled via a command. The Laser-Vacuum Head 500 is oriented such that the Suction Head 515 then adheres to an Object 1000 during transit of the Laser-Vacuum Head 500, facilitating the application of adhesive to the bottom of the Object 1000 by gliding the layer over the top of the Upper Roller 403 as depicted by FIG. 7b. From there, the Object 1000 is retained by the Suction Head 515 until the Laser-Vacuum Head 500 is relocated to a desired location within the Material Stacking Plane 120, and the Head Motor 512 is disabled via a command to place the Object 1000 at a location (optionally in contact with one or more previously placed Object(s) 1000) within the Material Stacking Plane 120.

In the preferred embodiment of the invention, the Adhesive Application System 400 comprises an Applicator Motor 401. In various embodiments, the Applicator Motor 401 is configured to rotate the one or more rollers associated with the Adhesive Application System 400. In the preferred embodiment, the Applicator Motor 401 rotates two rollers of the Adhesive Application System 400 via a gear linkage placed at the end of the two rollers distal from the placement of the Applicator Motor 401 near the opposite end of the two rollers. In the preferred embodiment, the Applicator Motor 401 generates rotation of the top of the two rollers. Affixed to the top roller at the opposite end of the Applicator Motor 401 is an Upper Gear 405. A corresponding Lower Gear 406 is attached to the Lower Roller 404. The rotational energy provided by the Applicator Motor 401 attached to the Upper Roller 403 is thereby transferred to the Lower Roller 404 to provide rotation of the Lower Roller 404 via the Upper Gear 405 and Lower Gear 406 in the preferred embodiment. In such way, the rotation of the Lower Roller 404 during the preferred method of use within the Adhesive Tray 410 allows for the continuous collection of adhesive from the Adhesive Tray 410 upon the outer aspect of the Lower Roller 404. The adjacency of the outer aspects of the Upper Roller 403 and Lower Roller 404 thereby facilitates the transfer of the adhesive from the Lower Roller 404 to the outer aspects of the ridges of the Upper Roller 403 in the preferred method of use. An Object 1000 retained by the Laser-Vacuum Toolhead 500 may then graze the upper aspect of the Upper Roller 403 while the Upper Roller 403 rotates to facilitate the transfer of the adhesive from the Upper Roller 403 to a surface of the Object 1000. In alternative examples of the Adhesive Application System 400, an adhesive dispenser is incorporated within the Laser-Vacuum Toolhead 500 and connected to an Adhesive Tray 410 or other Adhesive receptacle to allow for the pumping and dispensing of adhesive directly via the Laser-Vacuum Toolhead 500.

Exemplary methods of use of the Vacuum Retention System 510, are performed in accordance with some or all of the following steps:

A method of operation of the system comprises the relocating the vacuum proximal to a desired layer step. Once the pickup location has been determined, during the relevant identifying the optimal point of vacuum contact step, in association with the controlling aspects of the system (in an embodiment the scripts and associated computer software configured to process the scripts), this location relative to a predetermined reference point located within the system is noted. In various embodiments, the predetermined reference point coordinates are labelled (0, 0, 0). In an exemplary use, each of the values is measured in a predefined unit. In an embodiment, each of the three values corresponds to the X-axis, Y-axis, and Z-axis coordinates, such that any positive or negative numbers replacing the zeroes correspond with a distance from the predetermined reference point. In an exemplary use, the retrieval location of the layer and the placement location of the layer correspond with values relative to the predetermined reference point. During an exemplary method of use, the relocating above a layer is accomplished by programmatically targeting a coordinate proximal to the desired retrieval point of the layer located within the Cutting Area 110 of the printer. During an exemplary use, the script is configured to proceed layer by layer, finding a location where that layer does not interfere with other layers that have already been arranged, and is inside the cutting region.

In the preferred embodiment, optionally in association with the relocating above a layer step, during the identifying the optimal point of vacuum contact step, the script further identifies the optimal location for the Suction Head 515 to interact with each layer during retrieval and relocation of the layer from the Cutting Area 110 to the Material Stacking Plane 120 while the Suction Head 515 is active, and the optimal location for the Suction Head 515 to deactivate to separate from the layer proximal to the Material Stacking Plane 120, and saves those optimal locations as coordinates within a file. Those skilled in the art will recognize that the coordinates may be stored in a file referred to as a “pick and place” file. These coordinates (optionally saved in a separate .txt file), and the outline of each of the layers associated with the model to be cut in the Cutting Area 110 are saved as a .DXF file in an embodiment of the system. In the preferred embodiment, the coordinates information and the .DXF file is utilized in association with scripts subsequently utilized by the computer software aspects of the system to generate commands operated by the printer to produce the modeled Object 1000. In various embodiments, those skilled in the art will recognize that the coordinates, outline, and associated configurations are the necessary inputs for the PrinterCtrl scripts associated with aspects of the Fusion360 software and related software are all the inputs necessary to generate commands to the printer. In an embodiment, the commands are transmitted to and readable by the computer software aspects of the system as a comma-delineated list. The comma-delineated list may comprise commands with an identifier and the data associated with the identifier. As will be appreciated by those skilled in the art, it can be seen some commands above have data that is either a 0 or a 1, i.e. they are turning something on or off. Other commands, such as the PWM commands, are integer values that set the power for power variable subsystems, such as the laser module. In various methods of use, the commands enable the actuation of different elements of the system—for example the one or more stepper motors, the laser, and the vacuum pump—to actuate the various elements of the system enabling them to perform the various steps of operation described herein. In accordance with the commands generated from the relevant controller scripts and associated computer software, the various motors of the system are actuated to relocate the Laser-Vacuum Toolhead 500 and its associated vacuum aspects to a location proximal to the desired layer to be retained by the Laser-Vacuum Toolhead 500 during the “relocating the vacuum proximal to a desired layer” step. The vacuum may then be actuated during the “activating the vacuum to retrieve the desired layer” step to retain the desired layer proximal to the Suction Head 515. An example of an Object 1000 being retained in accordance with the teachings of of this step is depicted in FIG. 2.

Following the actuation of the laser and retention of a layer, in an embodiment the applying adhesive to the desired layer step is performed. During this step, in the preferred embodiment, the retained layer is relocated to graze the Upper Roller 403 of the Adhesive Application System 400 as described elsewhere herein. In an alternative embodiments, an additional adhesive application dispenser is integrated within the Laser-Vacuum Toolhead 500 to allow the transfer of adhesive to the top of a layer after the layer has been placed, in association with alternative configurations of the system, and in particular alternative examples of the Adhesive Application System 400.

Following the applying adhesive step, the layer is relocated in accordance with the teachings of the invention proximal to the Material Stacking Plane 120 during the “placing the desired layer proximal to the Material Stacking Plane 120” step. Once the Laser-Vacuum Toolhead 500 retaining the layer is relocated to the desired location proximal to the Material Stacking Plane 120, the suction generated by the Vacuum Retention System 510 is terminated to release the held layer during the “deactivating the vacuum to release the desired layer” step. In accordance with the methods of use of the system, the various steps are repeated to accomplish stacking of the layers on or proximal to the Material Stacking Plane 120 to achieve the desired outcome associated with a 3D-printed Object 1000.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents, including the inclusion of plural or singular aspects of the system otherwise than as described herein. It is intended that the following claims define the scope of the invention and that methods and structures within the scope of these claims and their equivalents be covered thereby.

We claim:

1. A three-dimensional printing system, comprising:
a) a laser cutting system;
b) a vacuum retention system;
c) an adhesive application system;
d) a material stacking plane;
e) a cutting area;
f) a ZY-axis frame;
g) a Y-axis crossbar; and
h) a platform base.

2. The system of claim 1, wherein the laser cutting system comprises a 450 nm wavelength laser capable of cutting and engraving a variety of materials.

3. The system of claim 1, wherein the vacuum retention system comprises a suction head and a vacuum pump, configured to retrieve and retain cut layers during relocation.

4. The system of claim 1, wherein the adhesive application system comprises an adhesive tray, an upper roller, and a lower roller, configured to apply adhesive to cut layers.

5. The system of claim 1, further comprising a plurality of motors for precise motion control, comprising X-axis motors, Y-axis motors, and Z-axis motors.

6. The system of claim 5, wherein the motors are 2 amp NEMA 17 stepper motors with 200 steps per revolution.

7. The system of claim 1, wherein the system is compatible with materials including wood, acrylic, plastics, paper, cardboard, leather, textiles, thin metals, glass, rubber, and foam.

8. A method of printing a three-dimensional object using the system of claim 1, comprising:
a) configuring a desired outcome;
b) placing material in the cutting area;
c) activating the laser cutting system to cut layers;
d) using the vacuum retention system to retrieve cut layers;
e) applying adhesive to the cut layers using the adhesive application system;
f) placing the cut layers on the material stacking plane; and
g) repeating steps c-f until the desired outcome is achieved.

9. The method of claim 8, further comprising using computer software to slice a 3D model into layers and generate instructions for the system.

10. The method of claim 9, wherein the computer software generates a .dxf file and a .txt file to direct the system to specific locations for picking and placing cut layers.

11. The system of claim 1, wherein the platform base is approximately 2420 mm long by 1540 mm wide, and 1180 mm tall, with the cutting area being approximately one square meter.

12. The system of claim 1, wherein the adhesive application system has a usable applicator width of approximately 890 mm.

13. The system of claim 1, wherein the vacuum retention system is configured to work with materials of varying surface textures and porosities.

14. The system of claim 1, wherein the system is scalable to accommodate different sizes of objects and production volumes.

15. The method of claim 8, further comprising orienting the object to be printed to optimize for structural integrity, material usage, or printing time.
